(19) United States
(12) Patent Application Publication
(10) Pub. No.: US 2018/0115171 A1
(43) Pub. Date: Apr. 26, 2018

(54) Battery System for Galvanic Mediated Power to Body Network Devices System and Method

(71) Applicant: BRAGI GmbH, Munchen (DE)

(72) Inventor: Peter Vincent Boesen, Munchen (DE)

(73) Assignee: BRAGI GmbH, Munchen (DE)

(21) Appl. No.: 15/720,139

(22) Filed: Sep. 29, 2017

Related U.S. Application Data
(60) Provisional application No. 62/412,610, filed on Oct. 25, 2016.

(51) Int. Cl. H02J 7/00; H01M 10/42; G06F 1/16

(52) U.S. Cl. CPC H02J 7/0021; G06F 1/163; H02J 7/0014; H01M 10/42

(57) ABSTRACT

A method for managing power within a network of wearable devices includes galvaniclly transferring a signal between a first device on the network of the wearable devices and a second device on the network of the wearable devices, harvesting the signal at the second device to provide power to the second device, and extracting power management data from the signal.

### RELATED APPLICATIONS

This application claims priority to U.S. Provisional Patent Application No. 62/412,610, filed Oct. 25, 2016, hereby incorporated by reference in its entirety.

### FIELD OF THE INVENTION

The present invention relates to wearable devices. More particularly, but not exclusively, the present invention relates to powering body network devices.

### BACKGROUND

Current technology is limited by the physical constraints of the human anatomy. Devices that intend to be used as wearables are limited further by the necessity for batteries to power them. Further, such devices are designed to provide greater accessibility while also providing the user with more information, more interactivity and more use cases.

Consequently, these devices consume inordinate amounts of power relative to the ability of a battery system to reliably and lengthily support them. What is needed is a new power delivery system that allows the greatest maximization of space for interaction with the user while simultaneously delivering the necessary energy to power them.

### SUMMARY

Therefore, it is a primary object, feature, or advantage to improve over the state of the art.

It is a further object, feature, or advantage to provide for a method of powering body worn devices.

It is a further object, feature, or advantage of the present invention to provide a new approach to creating a stable power supply for the new form factor wearable devices.

It is a still further object, feature, or advantage of the present invention to provide power to a remote wearable device in a Personal Area Network.

Another object, feature, or advantage is to provide power to an array of remote wearable devices in a Personal Area Network.

Yet another object, feature, or advantage is to provide a linkage among various devices with power supplies to provide power to the Personal Area Network.

A further object, feature, or advantage is to allocate power amongst the various power bearing devices in the Personal Area Network so that maximum levels of power can be obtained.

A still further object, feature, or advantage is to allocate power amongst the various power bearing devices in the Personal Area Network so that allocation can be based upon the available amount of power contained in the power containing devices.

Another object, feature, or advantage is to increase efficiency.

Yet another object, feature, or advantage is provide the ability to design wearables to the requirements of the area where it resides without the constraints imposed by conventional power sources.

A further object, feature, or advantage is the ability to power a device for a great length of time due to the ability to have interconnected but remote power supply from the wearable device.

A still further object, feature, or advantage is the ability to maximize the amount of available space for different wearable device applications.

Another object, feature, or advantage is the ability to transmit data and energy simultaneously.

Another object, feature, or advantage is to reduce the constraints imposed by battery requirements associated with body worn accessories or devices. One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, a method for managing power within a network of wearable devices includes galvanically transferring a signal between a first device on the network of the wearable devices and a second device on the network of the wearable devices, harvesting the signal at the second device to provide power to the second device, and extracting power management data from the signal.

According to another aspect, a battery system for galvanic mediated power to body network devices includes at least one battery cell, at least one pair of electrodes for galvanic contact with a skin of a user, power circuitry for sending a power signal through the at least one pair of electrodes to a remote body worn device, and a data transceiver for galvanically communicating data with the remote body worn device.

### BRIEF DESCRIPTION OF THE DRAWINGS

FIG. 1 illustrates a first device and a second device connected through galvanic coupling.

FIG. 2 illustrates a device configured to receive power and/or data through galvanic coupling.

FIG. 3 illustrates a device configured to send power and/or data through galvanic coupling.

FIG. 4 illustrates one example of a set of wearable devices in the form of a left ear piece and a right ear piece.

FIG. 5 illustrates an example of a device configured to send and receive power and data.

### DETAILED DESCRIPTION

A battery system is carried or worn by a user which uses galvanic fields to provide the steady power required for the ongoing usage of one or more wearable devices. The battery system may provide a vast amount of stable energy to power one or more wearable devices thereby allowing the device to be used for great amounts of time and the ability to power multiple devices in an array and coordinate signals through the system simultaneously.

The present invention provides for the use of galvanic transmission of a personal area network to power the devices remote from the wearable device that is of a form factor large enough to provide the electromagnetic field which will power device. One such device is an earpiece wearable or bilateral earpiece wearable that takes advantage of a dual power supply as both a left ear piece and a right ear piece may each have its own power supply. This doubles the available power for the output of the electromagnetic fields, and may be used to provide more power at a single timeframe, or alternatively provide for twice the length of time for electromagnetic field generation. This allows for the ability of the devices to provide power to an array of devices over time, as well as to potentially allocate available power resources among devices based on their available power source as well as level of charge.

The present invention contemplates that the human body may be used as a transmission media for communicating electrical signals between different devices including wearable devices. The electrical signals may be data signals or may be signals to convey power.

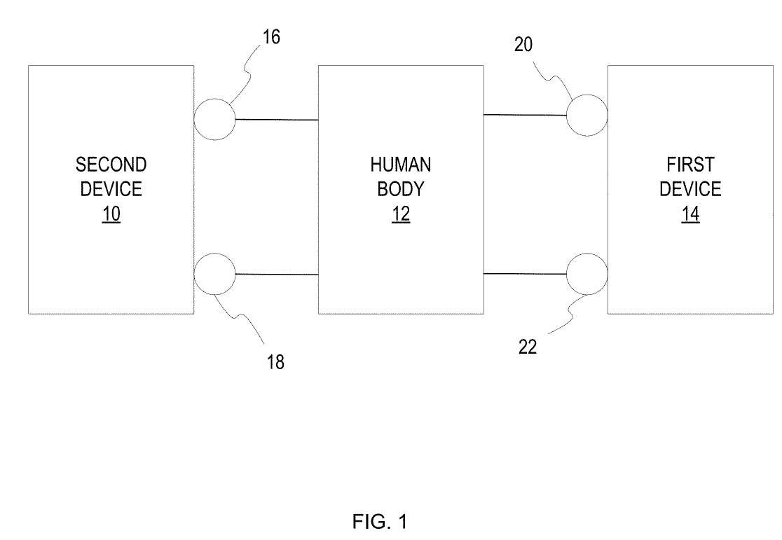

FIG. 1 illustrates a first device 14 of a personal area network with a first device 14 galvanically coupled to a second device 10 through a human body 12. The first device 14 has electrodes 20, 22 which may be placed in operative contact with the skin on the human body. The second device 10 which is located remotely from the first device 14 has electrodes 16, 18 which are in operative contact with the skin on the human body. The first device 14 and the second device 10 may communicate power and/or data therebetween. The first device 14 may be a wearable device and the second device 10 may also be a wearable device. Each of the first device 14 and the second device 10 may be ear pieces. One of the devices may have a primary purpose as serving as a battery system or power source.

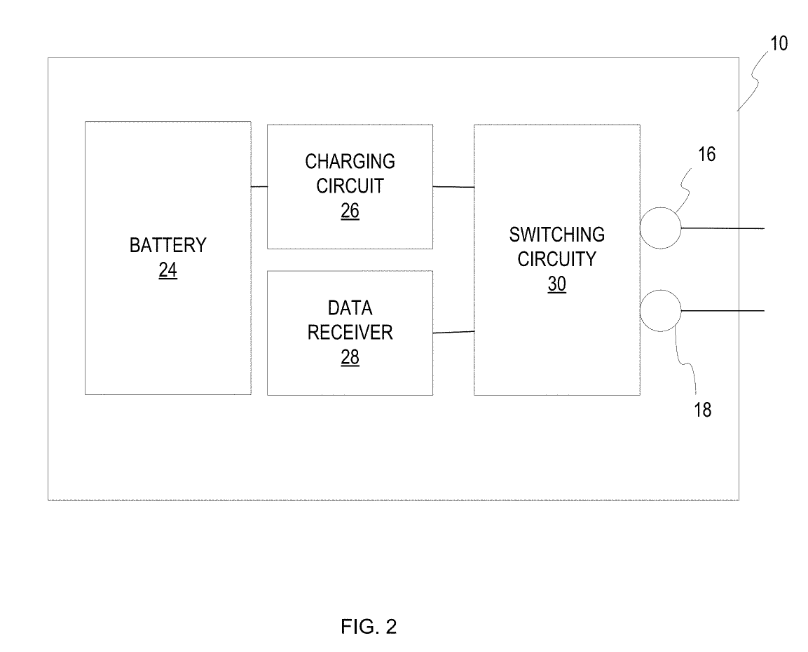

FIG. 2 illustrates a further example of the second device 10. The second device 10 may have a battery 24 which may include at least one battery cell. In the example shown, there is switching circuitry 30 which is operatively connected to electrodes 16, 18. The switching circuitry 30 may be used to switch between galvanic coupling for data communications and galvanic coupling for power communications. Thus, as shown in FIG. 2, the data receiver 28 may receive data communicated through the human body and the charging circuit 26 may receive a power signal communicated through the human body. The charging circuit 26 may be used to charge the battery 24.

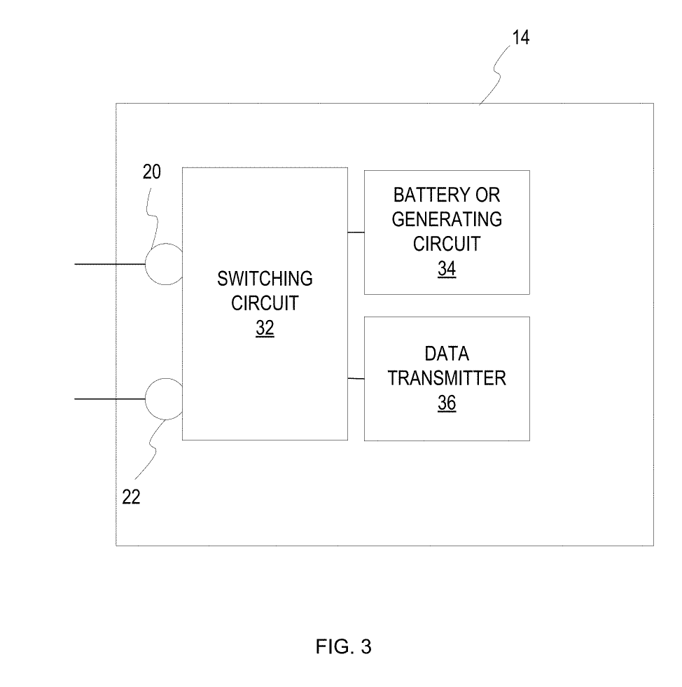

FIG. 3 illustrates a further example of a first device 14. As shown in FIG. 3, a switching circuit 32 is shown which may be used to switch between a battery of a current generating circuit 34 and a data transmitter 36. Thus, the first device 14 may be used for communicating power over or through the human body or data or through the human body. The current generating circuit 34 may be used to generate current in any number of ways. Thus, one of the devices used may not merely use power from a battery but may generate power. For example, the device may include a piezoelectric or magneto restrictive material that may generate charge in response to various forces or motions applied by a user. This generated charge may be conveyed to one or more other devices to recharge batteries. Of course, any number of other self-generating of electricity may be used.

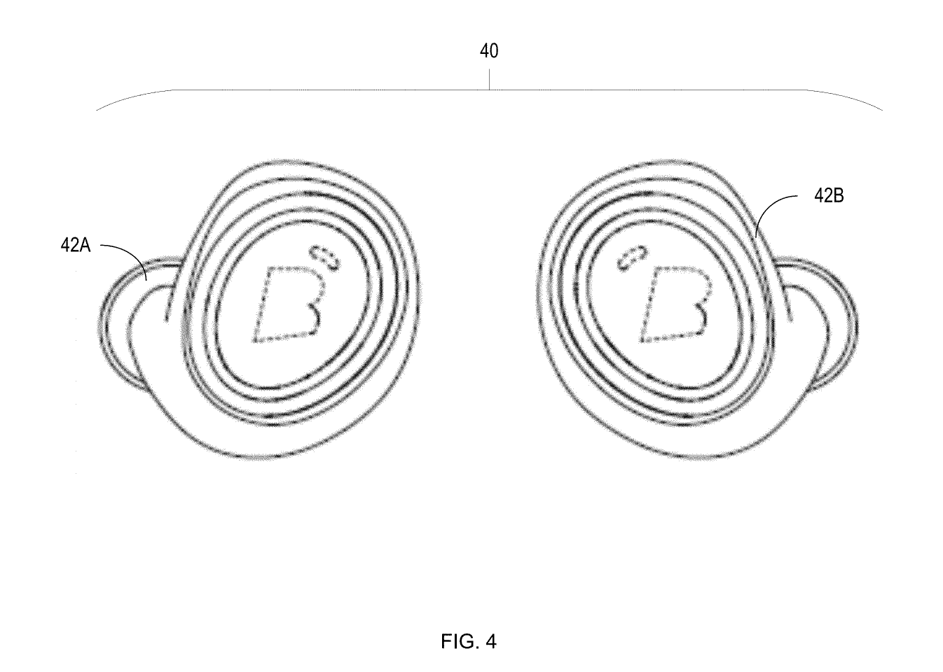

FIG. 4 illustrates a set of earpieces 40 with a left ear piece 42A and a right ear piece 42B. Although ear pieces are shown, it is contemplated that any number of other devices associated with a personal area network may be used. It is contemplated that any number of personal area network devices may be used and this may include, without limitation, goggles, glasses, helmets, headbands, smart caps, headphones, headsets, hats, mouth guards, eyewear, headwear, harnesses, arm bands, watches, gloves, jackets, shirts, vests, pants, socks, shoes, buttons, jewelry items, necklaces, rings, clips, bands, pads, articles of clothing, and other types of devices. The wearable devices may be medical devices, fitness devices, gaming devices, industrial devices, lifestyle devices, or other types of devices. The electrodes of the devices may be placed in contact with skin of a user. It is further contemplated that any number of different devices and any number of different types of devices may be present on the personal area network. A single device may be used to communicate outgoing data or charge with one or multiple other devices. Similarly, a single device may be used to receive data or charge from one or multiple other devices.

According to another aspect, it is to be understood that power management may be needed to manage a number of disparate devices that may potentially draw power from other devices on the same network. In addition, it is to be understood that on a single personal area network or body area network there may be a number of different devices with their own power requirements, their own power sources (battery or self-generating), and other variables.

The same signal used to communicate power may also be used to communicate data. For example, a data signal can be modulated in various ways (including on-off-keying) and super imposed on a high-frequency carrier so it can be sent galvanically along with the power signal. Of course, the data may be otherwise combined with the power signal. For example, the signal transmitted may be primarily a data signal which is rectified to provide a power signal.

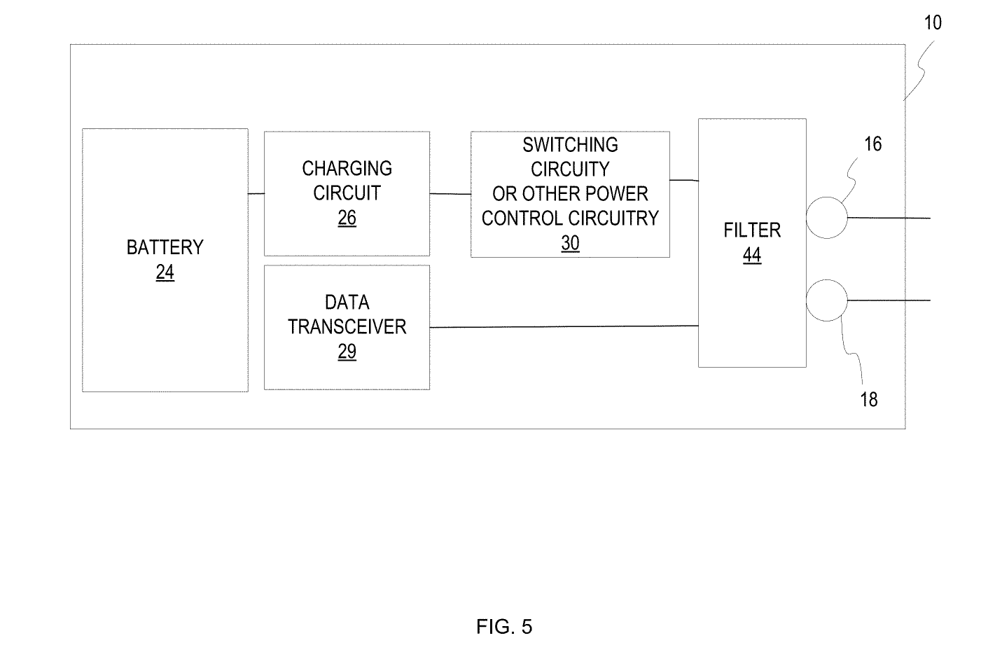

FIG. 5 illustrates one embodiment of a device where data and power are sent through a galvanic connection. As shown in FIG. 5, a filter 44 is present and may be used to filter higher frequency signals containing data from the power signal (although other types of filtering may be performed). The signal containing data may be communicated to the data transceiver 29.

To manage power consumption, it is contemplated that messages may be sent between different devices on the network. In one simple form, a message can indicate one or more of the following:
A device identifier.
Whether the device can function as a power source, a power consumer, or both.
Whether the device has power storage available or not.
Charge level (where the device has onboard storage).
Available modes of operations (such as power off, stand by, power on, power charging, power sourcing)
Power consumption requirements for operation or for different modes of operation.

In addition, messages sent or received can include commands. The commands may identify another device (such as using its device identifier) and include commands to turn off the other device, place the other device in a different mode of operation, or request information from the other device regarding its status or otherwise. Where the command is to put the device in a different mode of operation, the mode of operation may be one that reduces power consumption. The intelligence to send and receive messages may be performed by a processor, system on a chip, or other circuitry including as a part of the power control circuitry 30.

Management of the power consumption may be performed by a single device or a plurality of different devices. Although it may be preferred that the device performing the power management have its own independent power source such as a battery and the device performing the power management have a user interface or indirect access to a user interface in order to interact with a user to allow the user to make determinations regarding power consumption or set power consumption preferences.

Therefore, methods, apparatus, and systems have been shown and described. Although various example are shown and described, the present invention is not to be limited to these specific examples as numerous variations, options, and alternatives are contemplated.

What is claimed is:

1. A method for managing power within a network of wearable devices, the method comprising:
galvanically transferring a signal between a first device on the network of the wearable devices and a second device on the network of the wearable devices;
harvesting the signal at the second device to provide power to the second device; and
extracting power management data from the signal.

2. The method of claim 1 wherein the power management data comprises a command.

3. The method of claim 2 wherein the command is a command to change a mode of operation of the second device, wherein in the change in the mode of operation of the second device changes power consumption of the second device.

4. The method of claim 1 further comprising powering the second device with the power.

5. The method of claim 1 further comprising charging a battery of the second device with the power.

6. The method of claim 1 wherein the first device is powered by battery.

7. A battery system for galvanic mediated power to body network devices, the battery system comprising:
at least one battery cell;
at least one pair of electrodes for galvanic contact with a skin of a user;
power circuitry for sending a power signal through the at least one pair of electrodes to a remote body worn device;
a data transceiver for galvanically communicating data with the remote body worn device.

8. The battery system of claim 7 further comprising a filter for separating the data from the power signal.

9. The battery system of claim 8 wherein the data comprises power data.

10. The battery system of claim 9 wherein the power data comprises messages.

11. The battery system of claim 10 wherein the messages comprises command messages.

12. The battery system of claim 11 wherein the command messages include a message to change mode of operation of the remote body worn device, wherein the change in the mode of operation changes power consumption of the remote body worn device.
